(19) United States
(12) Patent Application Publication
(10) Pub. No.: US 2010/0043052 A1
(43) Pub. Date: Feb. 18, 2010

(54) APPARATUS AND METHOD FOR SECURITY MANAGEMENT OF USER TERMINAL

(75) Inventors: Wonjoo Park, Daejeon-city (KR); Kiyoung Kim, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecomunications Research Institute, Daejeon (KR)

(21) Appl. No.: 12/536,044

(22) Filed: Aug. 5, 2009

(30) Foreign Application Priority Data
Aug. 14, 2008 (KR) 10-2008-0079787

(51) Int. Cl. G06F 21/00

(52) U.S. Cl. 726/1

(57) ABSTRACT

The present invention relates to an apparatus and method for security management of a user terminal. The present invention generates security policies for the user terminal through an external security management server based on context information for the user terminal. At this time, the present invention receives the generated security policy information and sets internal security policies for the user terminal. The present invention can overcome a limitation of the user terminal as the security policies for the user terminal, particularly, the complex terminal is set by using various interfaces and provide systematic and supplemental security services.

### RELATED APPLICATIONS

The present application claims priority to Korean Patent Application Serial Number 10-2008-0079787, filed on Aug. 14, 2008, the entirety of which is hereby incorporated by reference.

### BACKGROUND OF THE INVENTION

1. Field of the Invention

The present invention relates to an apparatus and method for security management of a user terminal, and in particular, an apparatus and method for security management of a user terminal that can set security policies for the user terminal using various interfaces.

2. Description of the Related Art

A user terminal used in a ubiquitous computing environment is being evolved into a complex terminal as an all-in-one form that has a higher-level of computing ability and more various functions than the existing user terminal in order to provide various services.

Herein, the complex terminal is advantageous in that the user terminal has portability and mobility, but disadvantageous in that the CPU performance and processing capability is lower than a fixed terminal such as a desktop PC and an amount of power supply and a size of a screen are limited.

Further, the complex terminal has various network interfaces according to the demands of a user using the terminal, which accordingly increases the vulnerability of security.

Therefore, in the ubiquitous environment, a development of a framework, which can provide a security function to the complex terminal simultaneously with receiving various services and systematically manage it, has been urgently demanded.

The security service for the existing user terminal is limited to a method of authenticating a user password provided at the time of releasing the terminal or a method of installing an antivirus program on a few of the products, but the future use of a complex terminal in the ubiquitous environment requires a method of providing various security functions as more flexible services are realized.

### SUMMARY OF THE INVENTION

It is an object of the present invention to provide an apparatus and method of security management of a user terminal capable of providing more improved security services as security policies for the user terminal, particularly, complex terminals set through various interfaces.

In order to achieve the above object, there is provided a method for security management of user terminal according to the present invention, including: collecting context information and transmitting it to a security management server that generates security policies for the user terminal; receiving security policy information generated from the security management server based on the context information for the user terminal; setting the internal security policies for the user terminal by using the received security policy information; and managing the security for the user terminal according to the set internal security policies.

Further, in order to achieve the above object, there is provided a method for security management of user terminal according to the present invention, including: receiving context information collected from at least one of the plurality of user terminals; generating security policies for the corresponding user terminals based on the received context information; and transmitting the generated security policy information to the corresponding user terminals.

Meanwhile, in order to achieve the above object, there is provided an apparatus for security management of user terminal, including: a communication module that is connected to a security management server generating security policies for the user terminal to transmit and receive data; a DB that stores security policy information for the user terminal received from the security management server connected through the communication module; and a controller that collects context information for the user terminal and transmits it to the security management server and receives the security policy information generated from the security management server based on the context information and sets the internal security policies for the user terminal.

Further, in order to achieve the above object, there is provided an apparatus for security management of user terminal having a security management server, the security management server including: a security policy generator that generates security policies for the corresponding user terminals based on context information collected from at least one of the plurality of user terminals; a DB that stores security policy information generated by the security policy generator and update information on the security policies for the user terminal; and a security policy management unit that manages the security policy information for the plurality of user terminals and provides the corresponding security policy information to the user terminal that requests the security policy information among the plurality of user terminal.

The present invention can overcome limitations of the user terminal due to the security policies for the user terminal, particularly, the complex terminals, can be set by various interfaces and provide systematic and supplemental security services.

### BRIEF DESCRIPTION OF THE DRAWINGS

FIG. 1 shows a system configuration diagram for explaining an apparatus for security management of a user terminal according to one embodiment of the present invention;

FIGS. 2A to 2C are block diagrams showing a configuration of the apparatus for security management of a user terminal according to one embodiment of the present invention; and

FIGS. 3 to 6 are flow charts showing an operational flow of a method for security management of a user terminal according to the present invention.

### DETAILED DESCRIPTION OF THE PREFERRED EMBODIMENTS

Hereinafter, exemplary embodiments of the present invention will be described with reference to the accompanying drawings.

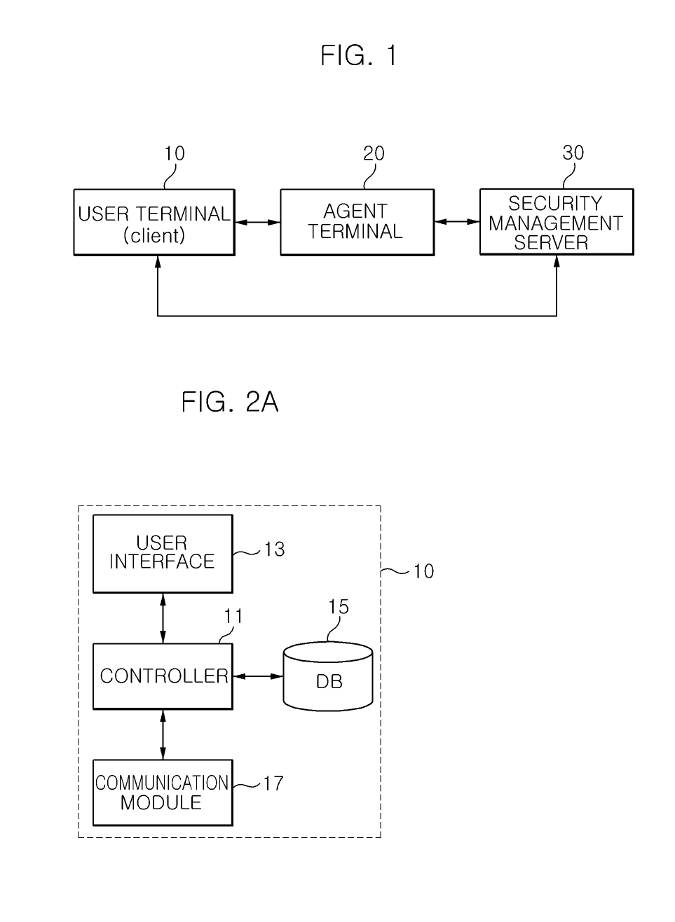

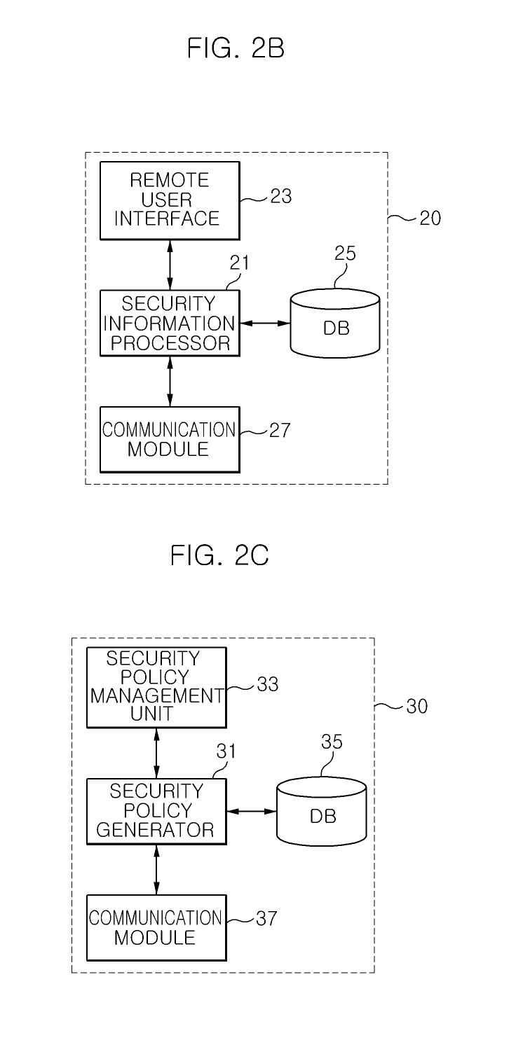

FIG. 1 shows a configuration of a system for security management to which a user terminal is applied according to one embodiment of the present invention and FIG. 2 shows a block diagram referenced for explaining the system configuration of FIG. 1.

Describing a system for security management of user terminal according to the present invention with reference to FIGS. 1 and 2, the system for security management of a user terminal according to the present invention is configured to include a user terminal 10, an agent terminal 20, and a security management server 30. At this time, the user terminal 10, the agent terminal 20, and the security management server 30 are each implemented as an apparatus for security management of the user terminal 10.

The user terminal 10, which is a client terminal, collects context information and transmits it to the security management server 30. At this time, the user terminal 10 requests security policies for the user terminal 10. Therefore, the user terminal 10 receives the security policy information generated from the security management server 30 based on the context information for the user terminal 10 and sets the internal security policies accordingly. Herein, when generating new security policies, the user terminal 10 can receive the new security policies from the security management server 30, but can receive it through a separate request. Meanwhile, the user terminal 10 itself may generate new security policies, but its authority should within a minimum range.

Herein, the user terminal 10 is used to support communication modules that can perform network communication, such as personal digital assistants (PDAs), portable multimedia players (PMPs), MPEG audio layer-3 players (MP3P), and mobile communication terminals, etc. Further, as the user terminal 10, a complex terminal used in a ubiquitous computing environment can also be used. Herein, the complex terminal where various network interfaces are added to the existing user terminal 10 acquires an all-in-one form that can receive various services in the ubiquitous environment by using the network interfaces.

Meanwhile, the agent terminal 20 can process a large-capacity data similar to a desktop PC and can set detailed items for the internal security policies for the user terminal 10 according to the request of the user terminal 10.

Further, the agent terminal 20 provides session services and synchronization services between the user terminal 10 and the security management server 30, such that it performs a role of relaying, transmitting, and receiving signals between the user terminal 10 and the security management server 30. At this time, the agent terminal 20 includes connection information on the plurality of user terminals 10 and performs an authentication process to the predetermined user terminal 10, such that it manages the security policy information for the user terminal 10 between the authenticated user terminal 10 and the security management server 30.

The security management server 30 is basically based on the context information of the user terminal 10 to generate security policies for each of the plurality of user terminals 10 and provide them to the user terminal 10. Herein, the security policies include all the internal security policies applicable to the user terminal 10, wherein the internal security policies may include a security policy according to an application operation, a security policy of enhancing security according to invasion information, etc.

At this time, the security management server 30 manages the security policy information generated for each user terminal 10. If there are a plurality of user terminals 10, they are formed in a group, such that they can be managed by a group or centralized method.

Moreover, the security management server 30 applies security setting authority for the user terminal 10 and the agent terminal 20. At this time, each of the user terminals 10, the agent terminal 20, and the security management server 30 have different levels of security policy setting authority. Herein, the security policy information includes identification codes for the plurality of user terminals 10 and performs the authentication process for the user terminal 10 by using the corresponding identification code.

At this time, the security management server 30 shares the security policy information for the authenticated user terminal 10, but may have different security policy information shared according to the security policy setting authority.

The configuration of FIG. 1 will now be described in more detail with reference to FIGS. 2A to 2C.

First, FIG. 2A is a block diagram showing a configuration of the user terminal according to the present invention. Referring to FIG. 2A, the user terminal 10 includes a controller 11 that sets security based on the security policy information provided through the security management server 30, a DB 15 that stores the security policy information provided by the security management server 30, and communication module 17 that supports the communication interface between the security management server 30 and the agent terminal 20.

In addition, the user terminal 10 provides a user interface (UI) 13 to receive predetermined control instructions from the user through the user interface. Herein, the user interface 13 is provided in a graphic user interface (GUI) form convenient to the user, but is not limited thereto.

The controller 11 can restrictively set the security for the user terminal 10 according to the level of authority applied by the security management server 30. At this time, the controller 11 requests the agent terminal 20 to set the detailed items for the security policies, such that it can apply the detailed security policies through the agent terminal. Further, the controller 11 collects the context information according to the request of the security management server 30 and transmits it to the security management server 30.

FIG. 2B is a block diagram showing a configuration of the agent terminal according to the present invention. Referring to FIG. 2B, the agent terminal 20 includes a security information processor 21 that transmits the security policy information for the user terminal 10 and its updated information to the user terminal 10 and sets the detailed information on the security policies for the user terminal 10 according to the request of the user terminal 10, a DB 25 that stores the security policy information and the update information thereto; and a communication module 27 that supports the communication interface between the security management server 30 and the user terminal 10.

Further, the agent terminal 20 provides a remote user interface (Remote-GUI) 23 that can be controlled by the user terminal 10 and receives the predetermined control instructions from the user terminal 10 through the remote user interface. Of course, the agent terminal 20 may directly receive the control instructions. Herein, the remote user interface 23 is provided in a graphic user interface (GUI) form.

FIG. 2C is a block diagram showing a configuration of the security management server according to the present invention. Referring to FIG. 2C, the security management server 30 includes a security policy management unit 31 that transmits the security policy information for the user terminal 10 to the user terminal 10 and the agent terminal 20 and manages the user terminal 10 based on the selected security policy, a security policy generator 33 that generates the security policies for the corresponding user terminal 10, a DB 35 that stores the security policy information generated through the security policy generator 33, and a communication module 37 that supports the communication interface between the user terminal 10 and the agent terminal 20.

Herein, the security policy management unit 31 applies security policy setting authority for the user terminal 10 and the agent terminal 20 and provides the predetermined security policy information accordingly. In addition, the security policy management unit 31 requests the context information for the user terminal 10 when generating new security policies. At this time, the security policy management unit 31 reads the context information received from the user terminal 10 and applies it to the security policy generator 33.

The operation of the present invention configured as described above will now be described.

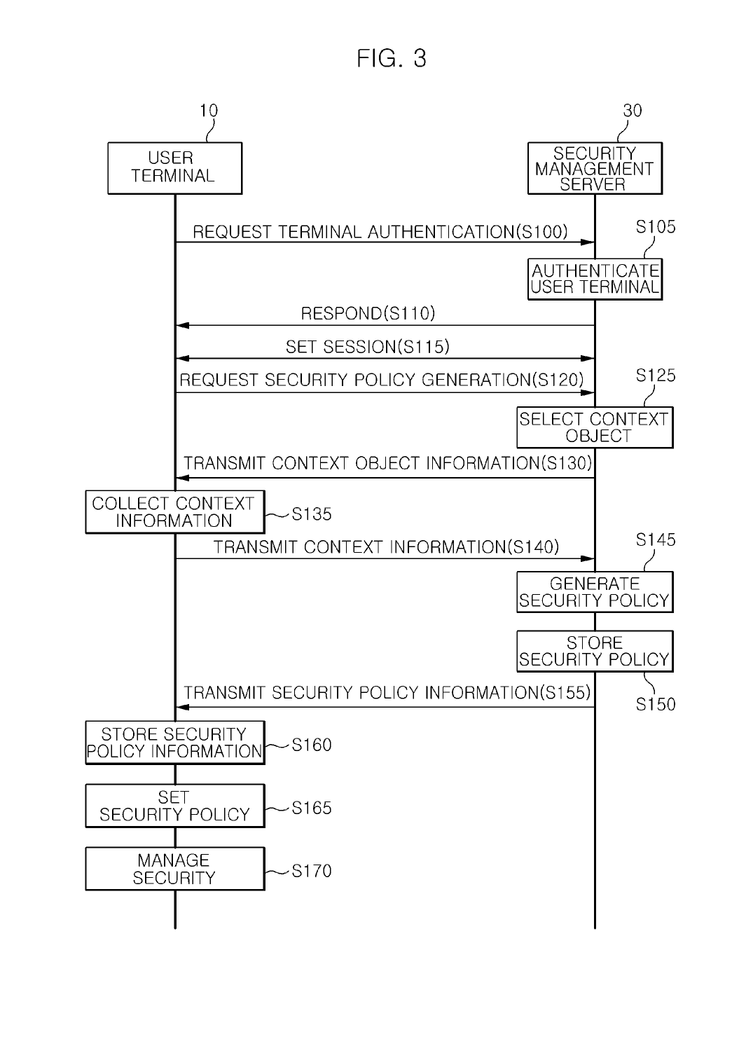

FIGS. 3 to 6 are flow charts showing an operational flow of the method for security management of the user terminal according to the present invention.

First, FIG. 3 shows an operational flow of allowing the security management server according to the present invention to generate new security policies for the user terminal. Referring to FIG. 3, the user terminal 10 requests authentication to the user terminal 10 prior to requesting the security management server 30 and generates new security policies (S100). At this time, the security management server 30 performs authentication for the user terminal 10 that requests authentication among the plurality of user terminals 10 (S105) and transmits a response signal to the corresponding user terminal 10 (S110), thereby setting a session between the user terminal 10 and the security management server 30 (S115).

The authenticated user terminal 10 requests the security management server 30 to generate security policies (S120). At this time, the security management server 30 selects a context object necessary to generate new security policies for the corresponding user terminal 10 (S125) and transmits the context object information to the user terminal 10 (S130). Meanwhile, the user terminal 10 collects the context information corresponding to the context object information received from the security management server 30 (S135) and transmits it to the security management server 30 (S140). Herein, the context information includes resource information, such as CPU state information, memory state information, power supply state information, application information, etc., on the user terminal 10 and includes security setting information, invasion information, invasion detection information, etc., which are set in the user terminal 10.

When the security management server 30 receives the context information collected from the user terminal 10, it generates new security policies based on the received context information (S145) and stores it in the DB(35) (S150). At this time, the security management server 30 manages new security policies generated for each user terminal 10. The security management server 30 stores the security policy information for the plurality of user terminals 10, in order to form a group of user terminals while managing the security policy information of the user terminal 10.

Further, the security management server 30 transmits the generated new security policy information to the corresponding user terminal 10 (S155). Herein, the security policy information stored in the DB 35 in the security management server 30 may be transmitted to the user terminal 10 through the agent terminal 20 that manages the security policy information for the user terminal 10 between the user terminal 10 and the security management server 30. At this time, the security policy information stored in the DB 35 can be immediately transmitted through the session but when the session is not set, can be transmitted to the agent terminal 20 while synchronization between the security management server 30 and the agent terminal 20 is performed. Likewise, the security policy information stored in the agent terminal 20 can be transmitted to the user terminal 10 while synchronization between the user terminal 10 and the agent terminal 20 is performed.

Therefore, the user terminal 10 directly receives the security policy information from the security management server 30 or receives the security policy information through the agent terminal 20.

Herein, synchronization means that the security policy information stored in the security management server 30, the agent terminal 20, and the user terminal 10 are synchronized and may share only some restricted information rather than all the information while the security policy information is shared among the security management server 30, the agent terminal 20, and the user terminal 10. For example, the agent terminal 20 can receive only some security policy information among the information stored in the security management server 30 and the user terminal 10 can receive only some security policy information among the information stored in the agent terminal 20. This may vary according to the level of authority set in the security management server 30, the agent terminal 20, and the user terminal 10, respectively.

Further, synchronization includes synchronizing the time of the security management server 30, the agent terminal 20, and the user terminal 10 by using a network time protocol (NTP) of the security management server 30.

Meanwhile, the user terminal 10 stores the new security policies received from the security management server 30 in the DB 15(S160) and sets the internal security policies for the user terminal 10 by using the stored new security policy information (S165). At this time, the user terminal 10 manages security based on the set internal security policies (S170).

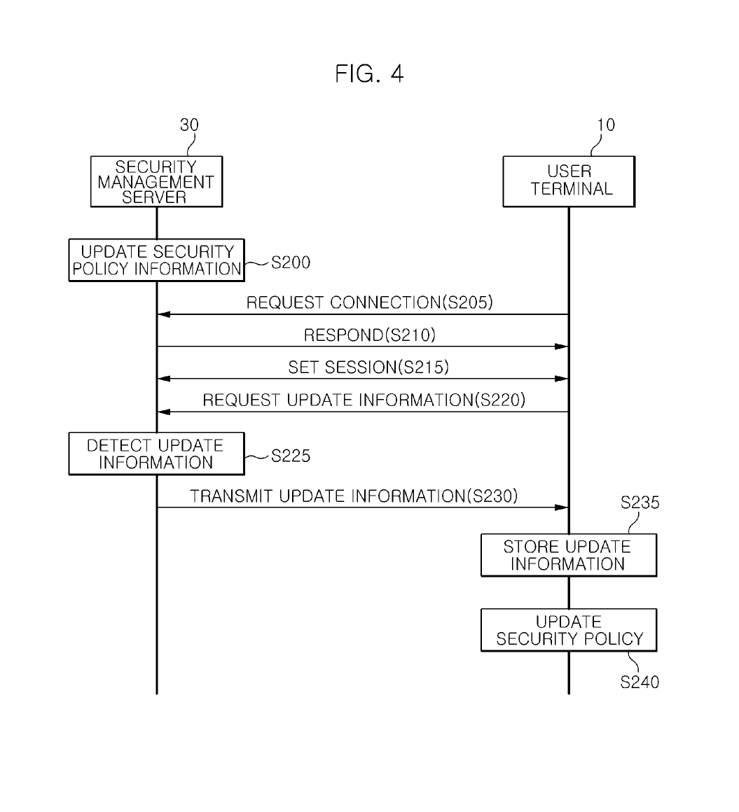

FIG. 4 shows an operational flow of updating the security policies for the user terminal according to the present invention. Referring to FIG. 4, the security management server 30 updates the security policy information for the user terminal 10 stored in the DB 35 (S200). The updated security policy information is stored in the DB 35.

Meanwhile, when the user terminal 10 requests the connection to the security management server 30 in order to obtain the updated security policy information(S205), the security management server 30 responds thereto (S210), the session is set between the user terminal 10 and the security management server 30 (S215).

When the session setting between the user terminal 10 and the security management server 30 is completed, the user terminal 10 requests the updated information on the security policies predetermined by the security management server 30 (S220). At this time, the security management server 30 detects the updated information corresponding to the corresponding security policies according to the request of the user terminal 10 (S225) and transmits it to the user terminal 10 (S230).

Herein, a case where when the security management server 30 receives the request of the user terminal 10, it provides the stored updated information, as an example, but when updating the security policy information, it can transmit a message informing the update. Further, upon updating, the security management server 30 can immediately transmit the updated information to the corresponding user terminal 10 without a separate request procedure.

The user terminal 10 stores the updated information received from the security management server 30 in the DB 15 (S235) and updates the corresponding security policy based on the stored updated information (S240). Therefore, the user terminal 10 sets the security according to the updated security policies.

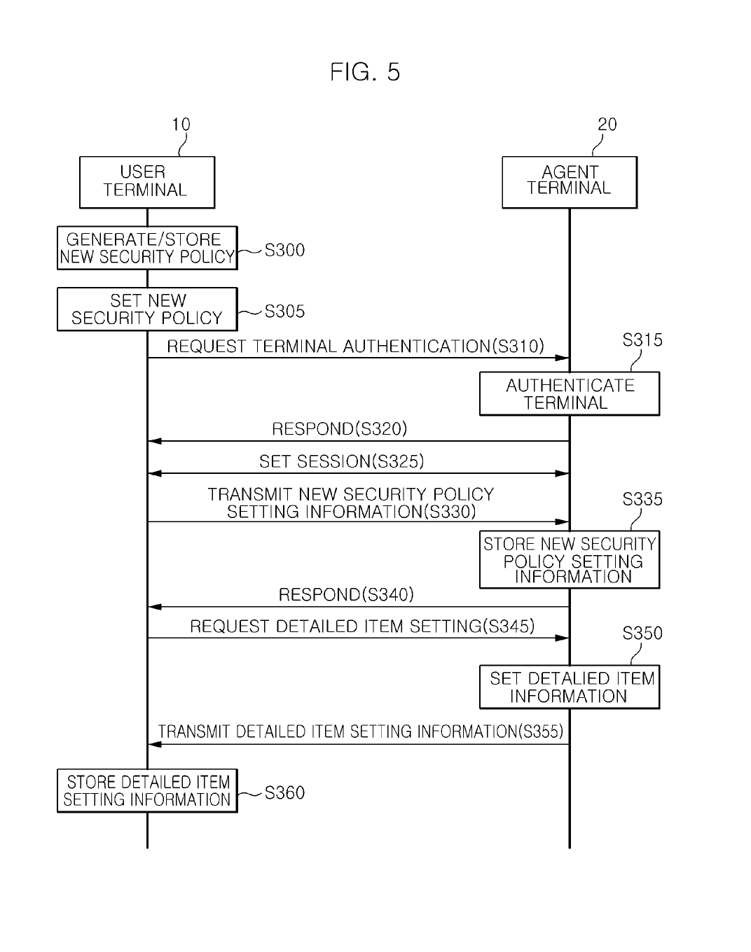

FIG. 5 shows an operation of generating the new security policies through the user terminal of the present invention. Referring to FIG. 5, the user terminal 10 generates the new security policies based on user instructions input through the user interface and stores it (S300). At this time, the user terminal 10 sets the security based on the generated security policies (S305). Herein, the new security policies generated by the user terminal 10 correspond to the most basic items or the urgent security policy setting items. However, the new security policies are not limited thereto and can be changed according to the setting.

Meanwhile, the user terminal 10 requests the agent terminal 20 to authenticate the user terminal 10 in order to transmit the new security policies to the agent terminal 20 (S310). The agent terminal 20 performs the authentication for the user terminal 10 (S315) and responds thereto (S320), such that the session is set between the user terminal 10 and the agent terminal 20 (S325).

When the setting session between the user terminal 10 and the agent terminal 20 is completed, the user terminal 10 transmits the new security policy setting information to the agent terminal 20 (S330). Of course, when the session is not set between the user terminal 10 and the agent terminal 20, the user terminal 10 can transmit the new security policy setting information when synchronizing between the user terminal 10 and the agent terminal 20. The agent terminal 20 stores the new security policy information received from the user terminal 10 in the DB 25 (S335) and responds thereto (S340).

In addition, the user terminal 10 requests the agent terminal 20 to set the detailed items for the predetermined security policies (S345). The agent terminal 20 sets the detailed items for the security policies according to the request of the user terminal 10 (S350). At this time, the agent terminal 20 receives the predetermined control instructions from the user terminal 10 to set the detailed items. Of course, the agent terminal 20 may directly receive the control instructions from the user.

The agent terminal 20 stores the security policies detailed setting information and transmits it to the user terminal 10 (S355). At this time, the user terminal 10 stores the detailed item setting information received from the agent terminal 20 (S360) and sets the security based on the stored security policies detailed setting information.

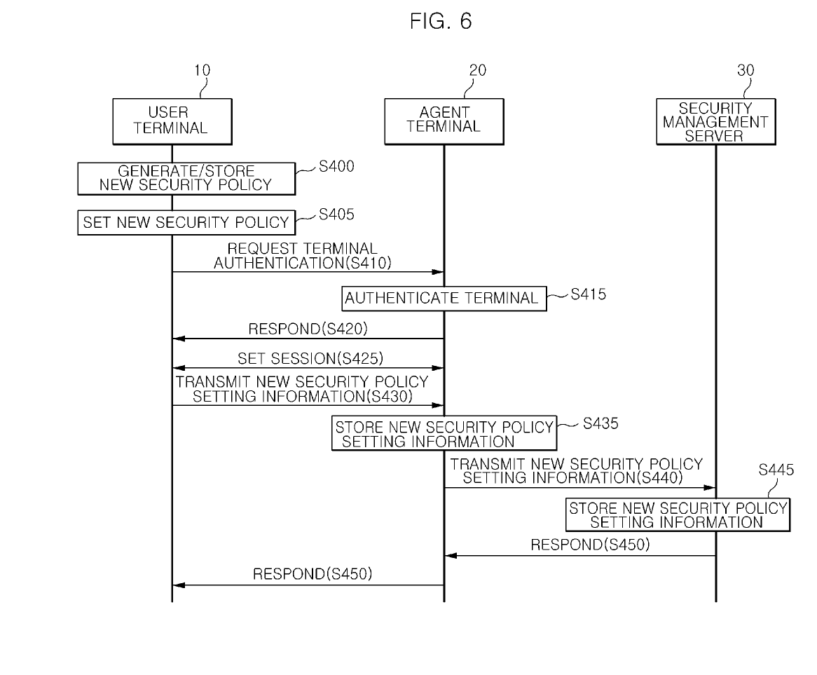

FIG. 6 shows another embodiment of FIG. 5 and shows a process of transmitting the new security policy information generated by the user terminal to the security management server through the agent terminal.

Referring to FIG. 6, the user terminal 10 generates the new security policies based on the user instructions input through the user interface 13 and stores it (S400). At this time, the user terminal 10 sets the security based on the generated security policies (S405). Herein, the new security policies generated by the user terminal 10 correspond to the most basic items or the urgent security policy setting items. However, the new security policies are not limited thereto and can be changed according to the setting.

Meanwhile, the user terminal 10 requests the agent terminal 20 to authenticate the user terminal 10 in order to transmit the new security policies to the agent terminal 20 (S410). The agent terminal 20 performs the authentication for the user terminal 10 (S415) and responds thereto (S420), such that the session is set between the user terminal 10 and the agent terminal 20 (S425).

When the setting session between the user terminal 10 and the agent terminal 20 is completed, the user terminal 10 transmits the new security policy setting information to the agent terminal 20 (S430). Of course, when the session is not set between the user terminal 10 and the agent terminal 20, the user terminal 10 can transmit and receive the predetermined information when synchronizing between the user terminal 10 and the agent terminal 20.

The agent terminal 20 stores the new security policy information received from the user terminal 10 (S435).

Meanwhile, the agent terminal 20 transmits the new security policy information for the user terminal 10 to the security management server 30 (S440). At this time, the security management server 30 stores the received new security policy information for the user terminal 10 (S445) and transmits the response signals to the agent terminal 20 (S450). Meanwhile, when the agent terminal 20 receives the response signals from the security management server 30, it transmits the response signals to the user terminal (S455) to inform the user terminal of it. Of course, the agent terminal 20 may transmit the response message to the user terminal 10 prior to transmitting the new security policy setting information to the security management server 30.

Therefore, the security management server 30 manages the user terminal 10 according to the new security policy information received through the agent terminal 20.

Herein, the new security policy information stored in the agent terminal 20 may be transmitted through the session generated between the agent terminal 20 and the security management server 30 or otherwise, may be transmitted while synchronizing between the agent terminal 20 and the security management server 30.

As described above, although the apparatus and method for security management of the user terminal according to the present invention is described with reference to the illustrated drawings, the present invention is not limited to the embodiment disclosed in the specification and the drawings but can be applied within the technical scope of the present invention.

What is claimed is:

1. A method for security management of a user terminal, comprising:
collecting context information and transmitting it to a security management server that generates security policies for the user terminal;
receiving security policy information generated from the security management server based on the context information for the user terminal;
setting the internal security policies for the user terminal by using the received security policy information; and
managing the security for the user terminal according to the set internal security policies.

2. The method for security management of a user terminal according to claim 1, wherein the context information includes at least one of terminal resource information, application information, interface information, and supportable security function information on the user terminal.

3. The method for security management of a user terminal according to claim 1, wherein the receiving the security policy information receives the security policy information from an agent terminal that manages the security policy information of the user terminal between the user terminal and the security management server.

4. The method for security management of a user terminal according to claim 1, further comprising receiving the security policy information updated from the security management server and updating the set internal security policies.

5. The method for security management of a user terminal according to claim 1, further comprising setting some security policies for the user terminal according to the request of the user.

6. The method for security management of a user terminal according to claim 5, wherein the setting the some security policies includes setting detailed items for the security policies for the user terminal by using the agent terminal that manages the security policy information of the user terminal between the user terminal and the security management server.

7. A method for security management of a plurality of user terminals, comprising:
receiving context information collected from at least one of the plurality of user terminals;
generating security policies for the corresponding user terminals based on the received context information; and
transmitting the generated security policy information to the corresponding user terminals.

8. The method for security management of a plurality of user terminals according to claim 7, wherein the context information includes at least one of terminal resource information, application information, interface information, and supportable security function information on the user terminal.

9. The method for security management of a plurality of user terminals according to claim 7, wherein the security policy information includes at least one of identification information and security policy setting time information on the corresponding user terminal.

10. The method for security management of a plurality of user terminals according to claim 7, wherein in the transmitting, the security policy information is transmitted through an agent terminal that manages the security policy information of the user terminal between the user terminal and the security management server.

11. The method for security management of a plurality of user terminals according to claim 7, further comprising updating at least one of the security policies for the plurality of user terminals and transmitting it to the corresponding user terminal.

12. The method for security management of a plurality of user terminals according to claim 7, further comprising setting a group of the plurality of user terminals and managing the security policies for the plurality of user terminals by a group.

13. An apparatus for security management of a user terminal, comprising:
a communication module that is connected to a security management server generating security policies for the user terminal to transmit and receive data;
a DB that stores security policy information for the user terminal received from the security management server connected through the communication module; and
a controller that collects context information for the user terminal and transmits it to the security management server and receives the security policy information generated from the security management server based on the context information and sets the internal security policies for the user terminal.

14. The apparatus for security management of a user terminal according to claim 13, wherein the controller updates the internal security policies for the user terminal based on the update information provided from the security management server.

15. The apparatus for security management of a user terminal according to claim 13, wherein the controller sets a detailed item for the some of the security policies through an agent terminal that sets some security policies for the user terminal according to the user request and manages the security policies for the user terminal between the user terminal and the security management server.

16. An apparatus for security management of a plurality of user terminals having a security management server, the security management server comprising:
a security policy generator that generates security policies for the corresponding user terminals based on context information collected from at least one of the plurality of user terminals;
a DB that stores security policy information generated by the security policy generator and update information for the security policies for the user terminal; and
a security policy management unit that manages the security policy information for the plurality of user terminals and provides the corresponding security policy information to the user terminal that requests the security policy information among the plurality of user terminal.

17. The apparatus for security management of a plurality of user terminals according to claim 16, wherein the context information includes at least one of terminal resource information, application information, interface information, and supportable security function information on the user terminal.

18. The apparatus for security management of a plurality of user terminals according to claim 16, wherein the security policy information is transmitted through an agent terminal that manages the security policy information of the plurality of user terminals between the plurality of user terminals and the security management server.

19. The apparatus for security management of a plurality of user terminals according to claim 16, wherein the security policy management unit imparts security policy setting authority to an agent terminal that manages the security policy information for the plurality of user terminals and the plurality of user terminals.
